(19) United States
(12) Patent Application Publication
(10) Pub. No.: US 2023/0321581 A1
(43) Pub. Date: Oct. 12, 2023

(54) COMPRESSED GAS FILTER WITH THROUGH-OPENING IN THE HOUSING HEAD

(71) Applicant: BEKO Technologies GmbH, Neuss (DE)

(72) Inventors: Johannes SINSTEDTEN, Korschenbroich (DE); Stefan KAMPFER, Köln (DE); Peter BEUMERS, Aachen (DE); Lennart OHLBERG, Düsseldorf (DE); Thomas PRIOR, Odenthal (DE); Jörg RAMBOW, Neuss (DE); Patrick BONN, Düsseldorf (DE)

(21) Appl. No.: 18/023,628

(22) PCT Filed: Aug. 13, 2021
(86) PCT No.: PCT/EP2021/072647

§ 371 Date: Feb. 27, 2023

(30) Foreign Application Priority Data
Aug. 31, 2020 (DE) 102020122652.7

(51) Int. Cl. B01D 46/24; B01D 46/00; B01D 46/42

(52) U.S. Cl. CPC B01D 46/2414; B01D 46/009; B01D 46/429

(57) ABSTRACT

A compressed air filter includes a housing and a housing head with an inlet and an outlet, wherein a preparation element is arranged in an interior of the housing, and compressed air which is to be prepared flows through the inlet into the preparation element and flows out through the outlet as prepared useful air. The housing head has a through-opening through which, in the state in which the preparation element is used, there extends a functional element connected to the preparation element.

### CROSS-REFERENCE TO RELATED APPLICATIONS

This application is a 35 U.S.C. § 371 National Stage patent application of International patent application PCT/EP2021/072647 filed 13 Aug. 2021, which claims priority to German patent application 102020122652.7 filed 31 Aug. 2020, the disclosures of which are incorporated herein by reference in their entirety.

### TECHNICAL FIELD

The disclosure relates to a compressed gas filter, for example, for compressed air or nitrogen. The compressed gas filter consists of a filter housing and a housing head with an inlet and an outlet. In the interior of the filter housing, there is a preparation element into which incoming compressed air flows through the inlet and flows out through the outlet as prepared useful air.

### BACKGROUND

In compressed air systems, the compressed air must be prepared in accordance with legal regulations and internal requirements. The possible quality classes for compressed air are defined in ISO8573-1: 2015. The standard specifies the proportions of solid particles, water and oil (aerosols) to be complied with.

Depending on the compressor performance, different treatment components are used to meet the required ISO8573-1: 2015 classes. In practice, compressed gas is prepared by filters, among other things. Preparation elements in filters separate the unwanted components of the pressurized gases.

Compressed air or compressed gases generated by compressors contain, for example, solid particles as well as water and oil in steam and droplet form. They come from the ambient air drawn in for the process, the cooling agents and lubricants of the system, abrasion due to wear or manufacturing residues. These components can cause disturbances in downstream systems and processes and must therefore be separated from the compressed air or compressed gas.

Systems consisting of pressure vessels with exchangeable preparation elements, such as filter nonwovens, adsorbers or separators, are widespread for this purpose. Compressed gas filters consist of a metallic housing and a housing head. The preparation element, for example a filter element, is located inside the metallic housing and is connected to the housing head. A sealing part on the preparation element cap (e.g., an O-ring) ensures that no contaminated fluids from the inlet side reach the outlet side of the filter in unfiltered form. To check the loading status of the preparation elements, many manufacturers use a differential pressure gauge or indicator as an indicator for a repreparation element change.

These preparation elements are adapted to the respective task for material separation and are usually equipped with identical interfaces to the housing. The interfaces allow, for example, the change of preparation elements, desired flow guides and often also a display of a fill level by means of sight glasses. Via channels in the vessel wall, the operating pressure in the flow direction before and after the preparation element can be recorded. This pressure tap allows the measurement of the differential pressure between the inlet and outlet sides of the filter, whereby the saturation state of a preparation element can be interpreted. When particles accumulate in the preparation element, the flow resistance and thus the pressure difference between the inlet and outlet side of the filter typically increases. Depending on the installation, it is cost-effective to replace the preparation element from a certain differential pressure and thus reduce the energy costs for compressed gas generation.

A commonly used measuring instrument to indicate the pressure difference is a differential pressure gauge or indicator. Embodiments with pressure connections on channels of the outer vessel wall are well known. Further embodiments comprise channels on the inner vessel wall in combination with a signal transmitter with magnetic transmission to a transducer with a display instrument on the outer wall. This embodiment can only be used for vessels made of non-magnetically shielding materials or for sufficiently small signal transmitters and transducers.

The identical interfaces have the advantage of a uniform and thus cost-effective housing design with identical parts. These housings are typically designed for nominal pressure ratings with operating overpressures up to 10, 16 bar and up to 500 bar.

To ensure compressive strength, the pressure-bearing parts of the filter are usually made of metallic materials (usually aluminium or steel alloys). The pressure-resistant filters usually consist of a housing head, which is connected to the preparation element via a plug-in, tie rod or threaded connection. The housing head is usually connected to a union nut, screw or bayonet connection with an oblong lower part of the housing. This provides the space for the preparation element.

Depending on the manufacturer, there is a plurality of preparation elements or filter element types that can be used in a housing. These include, for example, preparation elements for different particle sizes or for the separation of oil aerosols. During assembly or maintenance, care must therefore be taken not to accidentally install the wrong preparation element. Since in a closed filter housing the installed preparation element type is difficult or not at all recognizable from the outside, there is a risk of confusion due to the plurality of different preparation elements.

Compressed air systems in which the various preparation elements are installed are usually serviced once a year by trained service personnel. Due to the isolation of the preparation element insert (activated carbon cartridge, dust filter, etc.) in the metallic filter housing, further disadvantages arise.

In many branches of industry (e.g., the food industry or medical technology), it is necessary to monitor compressed air quality using process technology. Since an aluminium housing acts like a Faraday cage, the signal transmission from the filter housing can hardly be realized or only with great effort.

Another disadvantage is the service or maintenance. It is not always possible for the service technician to identify the installed preparation element right away. Limited visibility due to poor lighting of the compressor room and cramped installation conditions make it difficult to identify the preparation element. In the event of maintenance, the service employees are dependent on the documentation of the type plate attached to the outside of the housing. However, this does not always contain all relevant information about the installed preparation elements. Furthermore, the nameplates can get dirty and are difficult to read. Depending on the installation position of the filter (e.g., type plate is aligned to the wall), neither the service technician nor the end user who wants to order new preparation elements has the possibility to identify the contents of the filter. In such cases, the relevant part of the compressed air system in which the filter is installed must be “depressurized” and the filter dismantled.

Even after opening the compressed gas filter, there may still be confusion between the preparation elements and serious errors during maintenance. Depending on the type of preparation element, the flow direction can take place in different directions. For example, a dust filter is flowed through from the outside to the inside, while a coalescing element is usually flowed through from the inside to the outer side to ensure the drainage of the condensate on the outside of the drainage layer.

Even during the initial installation and/or retrofitting of complete filters in the compressed air system, there may be confusion of the installation direction. The identification of the installation and throughput direction of filters is often only visible via a sticker on the outer side of the filter or on the differential pressure gauge (if available).

### SUMMARY

Based on this, the disclosure provides an improved compressed gas filter. In particular, the operational safety and reliability as well as the efficiency or performance of the compressed gas filter over the service life are to be increased.

According to the disclosure, the advantage is achieved by providing a compressed gas filter, the housing head of which has a through-opening, through which a functional element connected to the preparation element extends into it in the state in which the preparation element is used.

The disclosure is based on the idea, contrary to the previously usual opinion, to provide a through-opening in the pressurized housing or housing head.

This allows information about the preparation element used itself, or its current state or generally about conditions inside the housing, for example, about pressure conditions or temperatures via corresponding functional elements extending into the through-opening, to the outside. For example, the functional element can be used for immediate identification of the built-in preparation element and/or the flow direction can be displayed directly. The functional element can also be used for signal transmission and fluid discharge.

The functional element can project according to the disclosure from an upper end cap of the preparation element upwards through the through-opening to the outside. In this case, it is, for example, an integral part of the preparation element and preferably formed onto the end cap. Alternatively, however, the functional element may also be formed by an additional element which is not physically connected to the preparation element, but is arranged in the through-opening.

Each preparation element (dust filter, water separator, fine filter, etc.) has its own specific marking. The functional element has an information surface visible from the outside in the state in which the preparation element is used. Information symbols may be attached to this information surface, which indicate, for example, the type of preparation element used. Also, information symbols, which indicate the flow direction within the compressed gas filter, such as easily recognizable arrows for example. Based on the arrow symbol, an incorrect installation direction of the preparation element would be immediately noticeable and protect the end application.

The information symbols according to the disclosure may not only be visually recognizable, but alternatively or additionally also haptically tactile. For this purpose, the information symbol is executed by corresponding elevations and recesses. This facilitates identification by specialists with poor eyesight (e.g., colourblind, farsighted people, etc.) or in poor visibility conditions (e.g., dust, darkness, etc.) at the installation site.

Preferably, the colour and/or shape of the functional elements, for example, round or square contour can also be used as an information carrier.

Advantageously, the functional and the preparation element may be designed in such a way that the functional element is movable in the axial direction in the through-opening, so that the functional element can occupy different positions in the through-opening depending on the pressure conditions in the compressed gas filter. The functional element itself is pushed slightly upwards by the operating overpressure and projects slightly opposite an outer surface of the housing head. If the filter is under pressure, the functional element projects a few millimetres from the housing head. This immediately signals to the specialist personnel that the filter is under pressure.

Before changing the preparation element, it is checked whether the functional element can simply be pushed down again. If this is not the case, the system is still under pressure and the filter housing must not be opened. This additional function increases the safety of personnel and the stability of the end application.

In a particularly favourable embodiment variant, the functional element comprises at least one fluid channel which connects the interior of the preparation element and/or the housing to the environment. This makes it possible to connect measurement technology directly to the compressed gas filter and/or the preparation element. For example, the fluid channels in the preparation element can be used to direct the static pressure from the inlet and outlet side of the preparation element to the outside. For this purpose, two corresponding fluid channels are provided, on the inlet and outlet side of the preparation element. The installation of measuring instruments (such as a differential pressure gauge or oil test indicator for example) is therefore very easy to implement.

Another advantage is an additional filter element installed in the fluid channel of the preparation element, which protects the measurement technology from contamination. This additional filter element is preferably part of the preparation element and is replaced with each change of the preparation element and thus increases the functionality of the measurement technology in the long term.

The through-opening has great advantages, particularly in an otherwise metallic filter housing, as it can preferably also be used to transmit signals of any kind (electronic, radio, wire, etc.) from an interior of the filter housing to the outside or also from the outside to the inside. The functional element or also an additional plug therefore offers an isolation function of the signal transmitter (e.g., wire) and the function of signal transmission/transmittance in the case of wireless signal transmission.

The through-opening and the functional element also allow the use of actuators and readable information carriers. These include RFID tags, NFC chips or actuators of any kind. These are preferably arranged in an end cap of the preparation element or in an additional plug and can make details of the preparation element (e.g., type of preparation element, degree of filtration, temperature, date of manufacture, batch number, etc.) automatically readable from the outside by means of appropriate readers. The usual metallic housings of filters do not allow this.

The use of the through-opening in combination with the functional element on the preparation element thus allows significantly easier handling during maintenance and/or assembly as well as an increase in process reliability.

The disclosure is also particularly suitable for membrane dryers which are selectively permeable to water vapour. In the housing of the compressed gas filter, a bundle of highly selective hollow fibre membranes (membrane fibres) is arranged, through which moist compressed air flows through the inlet. Water vapour diffuses outwards through the hollow fibre membranes. At the outlet for dried compressed air, a small partial flow of compressed air is diverted and used as purge air after expansion. The purge air is fed in counterflow to the compressed air over the outer side of the hollow fibres. This process takes place continuously. The purge air constantly dries the inflowing, moist compressed air. Only water molecules can penetrate the membranes of the hollow fibres. The composition of the dried compressed air remains unchanged. The result is pure, dry compressed air with a low-pressure dew point.

The disclosure is explained in more detail on the basis of the following figures. These should not be understood restrictively, but only show principal illustrations of the disclosure. It is explicitly pointed out that the individual different described embodiments and uses of the functional element, for example, the transmission of information by the colour and or shape, the optical and/or haptic information symbols, the use of fluid channels and readable information carriers or also the selection of a suitable material for the transmission of signals can be combined in a suitable manner.

In principle, the disclosure is also suitable for flange filters, which also have preparation elements arranged in a housing, often a plurality in a single housing. Since there are also different types of preparation elements for flange filters, it is also useful for these if it is recognizable from the outside which type is inside a closed housing. In addition, flange filters can also be operated with a different number of preparation elements, for example, one to four preparation elements can be used. According to the disclosure, a through-opening is provided for each usable preparation element, into which a connected functional element extends in the state in which the preparation element is used. If fewer preparation elements are used than there are through-openings, the through-openings are closed by means of blank plugs, wherein the blank plugs are easy to recognize from the outside, for example due to their colour. Thus, it is not only quick and easy to see from the outside which preparation element types are installed, but also how many preparation elements are arranged in the housing.

### BRIEF DESCRIPTION OF THE DRAWINGS

The figures show:

FIG. 1: a housing head according to the disclosure and a preparation element according to the disclosure in perspective illustration,

FIG. 2: the housing head according to the disclosure from FIG. 1 with a pressure indication,

FIG. 3: a second embodiment variant of a housing head according to the disclosure with an additional filter,

FIG. 4: a embodiment variant of a preparation element according to the disclosure with fluid channels,

FIG. 5: an embodiment variant of an end cap of a preparation element according to the disclosure with readable information carrier,

FIG. 6: a flange filter according to the disclosure in a cross-section, and

FIG. 7: a top view of a housing head of the flange filter from FIG. 6,

### DETAILED DESCRIPTION OF THE DRAWINGS

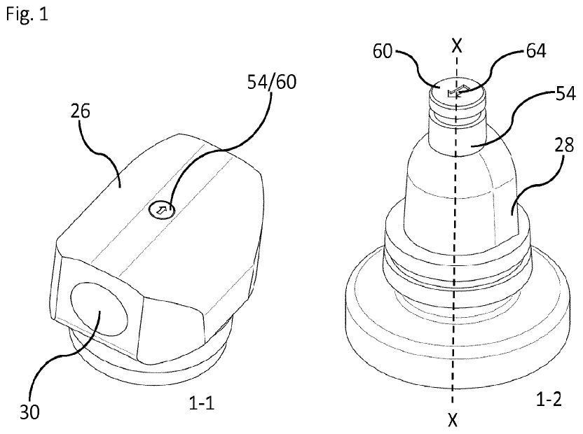

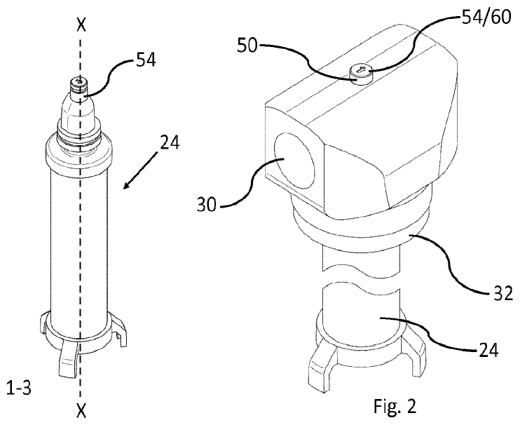

FIG. 1 shows a housing head 26 of a compressed gas filter 20 according to the disclosure (FIG. 1-1), an end cap 28 of a preparation element 24 in enlarged illustration (FIG. 1-2) and the preparation element 24 itself (FIG. 1-3).

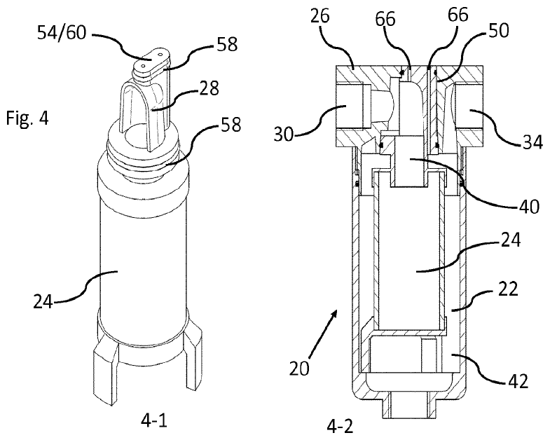

A compound compressed gas filter 20 according to the disclosure shows, for example, FIG. 4 in section. The housing head 26 is connectable to a housing 22 in which the preparation element 24 is arranged. In the operating state, the preparation element 24 is also connected to the housing head 26. Through an inlet 30, compressed gas, for example compressed air or nitrogen, passes through the housing head 26 into an interior 40 of the preparation element 24, enters in the exemplary embodiment shown by a cylindrical preparation component (e.g., filter fleece or membrane) in a housing interior 42, i.e., a annular space between the preparation element 24 and the inner wall of the housing 22. From the housing interior 42, the compressed gas finally flows out through an outlet 34 as prepared useful air from the housing head 26.

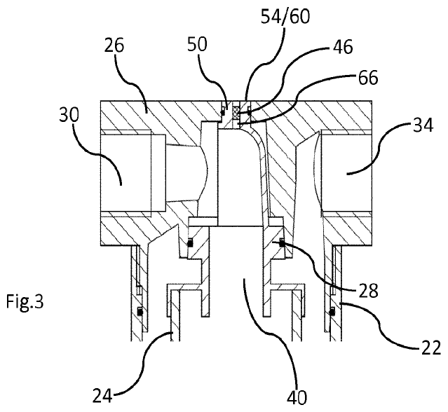

FIGS. 3 and 4 illustrate that a functional element 54 arranged at an end cap 28 extends through a through-opening 50 arranged on a free end face of the housing head 26. In the exemplary embodiment shown, the functional element 54 and the end cap 28 are designed as an individual single-piece component. The end cap 28 is located in the assembled state of the compressed gas filter 20 within the housing head 26.

The functional element 54 extends coaxially to a longitudinal axis x-x of the preparation element 24 away from the end cap 28 and projects cylindrically. The outer contour of the functional element 54 is adapted to the shape of the through-opening 50 in such a way that they can functionally interact and the through-opening 50 can be sealed against the functional element 54. The length of the functional element 54 projecting from the end cap 28 is adapted to the structure of the housing head 26 in such a way that the functional element 54 projects into the through-opening 50. The coaxial arrangement of the functional element 54 and the preparation element 24 allows screwing in the preparation element 24 with a functional element 54 having a round cross-section.

FIG. 1 also shows that the functional element 54 has an information surface 60 at its free distal end, which is visible from the outside in the assembled state of the compressed gas filter 20. On the information area 60, an arrow is shown as information symbol 64 in the exemplary embodiment shown. The arrow indicates the flow direction of the compressed gas through the compressed gas filter 20 in the assembled state. In particular, the arrow can also be raised or recessed, so that it is not only visually visible, but also palpable.

FIG. 2 illustrates a particularly favourable embodiment variant of the disclosure. Accordingly, the functional element 54 is movable in the axial direction in the front surface of the housing head 26 arranged through-opening 50, so that it projects more or less far over an outer surface of the housing head 26, depending on the pressure conditions in the compressed gas filter 20. In FIG. 2, the state is shown in which there is overpressure in an interior 42 of the compressed gas filter 20, so that the functional element 54 is pushed upwards from the housing head 26. Thus, it can be seen at first glance that the compressed gas filter 20 is not depressurized. Also, it can be tested via a pressure test whether the functional element 54 can be pressed back in the direction of the interior 42. This would be the case, for example, if it had only got stuck in the upper position due to soiling. However, if the compressed gas filter 20 is still under overpressure, pushing back is not possible or only with great difficulty.

FIG. 2 further shows a thread 32, via which the housing head 26 can be screwed to the housing 22.

FIG. 3 shows another variant of the disclosure according to the disclosure. The functional element 54 comprises a fluid channel 66 connecting an interior 40 of the preparation element 24 to the environment. For example, measuring devices can be connected to this fluid channel 66. Also recognizable is an additional filter 46, which is arranged in the fluid channel 66 of the functional element 54 and protects the preparation element 24 from contamination.

FIG. 4 illustrates an embodiment variant in which two fluid channels 66 are provided. FIG. 4-1 shows a preparation element 24 in perspective and FIG. 4-2 shows the corresponding compressed gas filter 20 in cross-section.

A first fluid channel 66 connects an inlet side, a second fluid channel 66 an outlet side of the compressed gas filter 20 to the environment. Furthermore, a seal element 58 designed as an O-ring is recognizable, which seals the functional element 54 in the through-opening 50. The seal element 58 is also provided in the other embodiment variants, even if it is not always recognizable or not shown.

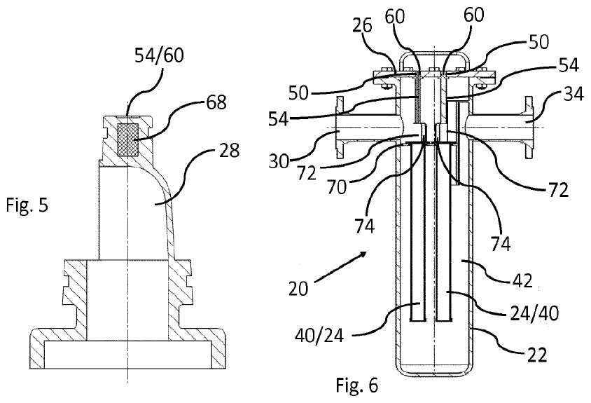

As shown in FIG. 5, another element may be accommodated within the functional element 54. In the embodiment shown a readable information carrier 68 is shown, which has stored, for example, information about the built-in preparation element 24.

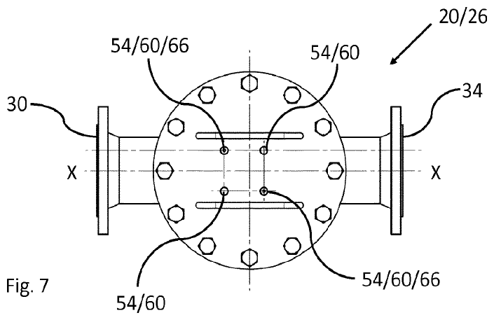

FIGS. 6 and 7 show a compressed gas filter 20 designed as a flange filter, in the housing of which 22 up to four preparation elements 24 can be arranged. FIG. 6 shows a cross-section along the section line X-X in FIG. 7, which is why only two preparation elements 24 can be recognized.

The preparation elements 24 extend through a retaining plate 70, whereby inlet elements 72 of the preparation elements 24 are located above the retaining plate 70 in the housing head 26. The inlet elements 72 each have inlet openings 74, through which through the inlet 30 inflowing compressed gas enters the preparation elements 24.

Of the inlet elements 72, functional elements 54 extend to through-openings 50 of the housing head 26. FIG. 7 illustrates that information surfaces 60 of the functional elements 54 can be recognized from the outside. In addition, two preparation elements have 24 fluid channels 66, to which measuring devices can be connected for example.

For example, the information surfaces 60 may symbolize various types of preparation elements 24. Alternatively, it may be recognizable how many preparation elements 24 are used in the compressed gas filter 60. Instead of a functional element 54 of a preparation element 24 used, a blank plug can be introduced into the corresponding through-opening 50 if no preparation element 24 is to be used. The blank plug seals the compressed gas filter 20 pressure-tight. Of course, flange filters according to the disclosure may also have the elements described above for other compressed gas filter types 20, for example actuators and readable information carriers (e.g., RFID tags, NFC chips or actuators of any kind).

The disclosure is not limited to the exemplary embodiment shown but also includes other variants which are feasible on the basis of the explanatory disclosure.

1. A compressed gas filter having a housing and a housing head having an inlet and an outlet, wherein in an interior of the housing a preparation element is arranged, into which through the inlet inflowing compressed gas and flows out through the outlet as prepared useful air,
wherein
the housing head has a through-opening through which a functional element connected to the preparation element extends into it in the state in which the preparation element is used.

2. The compressed gas filter according to claim 1, wherein between the functional element and the through-opening a seal element is arranged, through which the through-opening is pressure-tightly closed in state in which the preparation element is used.

3. The compressed gas filter according to claim 1, wherein the functional element has an externally visible information surface in the state in which the preparation element is used.

4. The compressed gas filter according to claim 3, wherein an information symbol is shown on the information surface.

5. The compressed gas filter according to claim 3, wherein, on the information surface, a haptically tactile information symbol is arranged, which has been designed with elevations and recesses.

6. The compressed gas filter according to claim 1, wherein within the functional element at least one fluid channel is embodied, which connects the interior of the preparation element to the environment.

7. The compressed gas filter according to claim 1, wherein within the functional element at least one fluid channel is embodied, which connects the interior of the housing to the environment.

8. The compressed gas filter according to claim 6, wherein within the fluid channel connecting the interior of the preparation element to the environment, an additional filter is arranged.

9. The compressed gas filter according to claim 1, wherein the functional element is made of an electrically insulating material.

10. The compressed gas filter according to claim 1, wherein the functional element is made of a material which enables the transmission of signals from the group electrical signals, electromagnetic signals, or radio signals.

11. The compressed gas filter according to claim 1, wherein the functional element comprises at least one electrical conductor which connects the interior of the preparation element and/or the interior of the housing to the environment.

12. The compressed gas filter according to claim 1, wherein the functional element and the preparation element are configured whereby the functional element in the through-opening is movable in the axial direction, so that the functional element takes different positions in the through-opening depending on pressure ratios in the compressed gas filter.

13. The compressed gas filter according to claim 1, wherein a readable information carrier is arranged within the functional element.

14. The compressed gas filter according to claim 1, wherein an actuator is arranged within the functional element.

15. A preparation element for a compressed gas filter comprising the features of claim 1.
